(19) United States
(12) Patent Application Publication
(10) Pub. No.: US 2002/0111698 A1
(43) Pub. Date: Aug. 15, 2002

(54) Web-based system for monitoring and/or controlling home devices

(76) Inventors: Marco Graziano, Menlo Park, CA (US); Christina Goddard, Palo Alto, CA (US); Andrew Over, Palo Alto, CA (US); Stathis Kassimidis, Hayward, CA (US)

Correspondence Address: Fabio Marino, SKJERVEN MORRILL MacPHERSON LLP, 25 Metro Drive, Suite 700, San Jose, CA, 95110-1349, US

(21) Appl. No.: 09/780,490

(22) Filed: Feb. 9, 2001

(51) Int. Cl. G05B 11/01

(52) U.S. Cl. 700/17; 700/19

(57) ABSTRACT

A web-based system that includes one or more remote devices, a web-based host, a network, and one or more homes is provided. A user can connect to the web-based host using a remote device via a network such as the Internet. The web-based host provides the user with an interface for monitoring and/or controlling home devices in the user's home. Via the interface, the user can select one or more home devices in the user's home to monitor and/or control. The web-based host receives the user's selections and communicates the user's selections to the user's home via the network. The user's home then receives the user's selections and causes monitoring information to be obtained from selected home devices and/or causes the behavior of selected home devices to be controlled according to the user's selections. The user's home can then communicate monitoring and/or other information related to the home devices to the web-based host via the network. The web-based host then communicates the monitoring and/or other information related to the home devices to the remote device via the network where the information is displayed.

### BACKGROUND OF THE INVENTION

1. Field of the Invention

The present invention relates to a web-based system for monitoring and/or controlling home devices.

2. Related Art

Systems for monitoring and/or controlling home devices have become increasingly popular in recent years. Such systems are used to control, monitor, manage, diagnose, and otherwise communicate with home devices such as lights, thermostats, or security systems.

Conventional systems for controlling and/or monitoring home devices are controlled using a home controller located in the home. The home controller is connected to various home devices and is operable to send commands to and receive information from the various home devices. A user can program the home controller to control the home devices according to the user's preferences.

Some conventional systems for controlling and/or monitoring home devices allow a user to access the home controller from a remote location using a device such as a telephone or a desktop computer. For example, a user can use a touch-tone telephone located in a remote location to connect with the home controller in the user's home. The user can then send commands to the home controller to control various home devices. For example, the user can turn lights on or off via the touch-tone phone.

Such conventional systems for controlling and/or monitoring home devices have at least the following disadvantages and limitations. First, the connection between the user's remote computer and the home controller is not secure. A user could establish a secure connection, but the cost and complexity involved in establishing such a connection is prohibitive. Second, such systems are complex for users to implement and maintain. For example, the home controller may be difficult to install. Third, programming such systems is cumbersome. Fourth, it is difficult for the user to access the home controller using different types of remote devices. Conventional systems only allow a user to access the home controller using, for example, a desktop computer located in the user's workplace.

What is needed is a system that overcomes the disadvantages and limitations of conventional systems for controlling and/or monitoring home devices.

### SUMMARY OF THE INVENTION

The present invention overcomes the disadvantages and limitations of conventional systems for controlling and/or monitoring home devices. The present invention accomplishes this by providing a web-based system for controlling and/or monitoring home devices.

The web-based system includes one or more remote devices, a web-based host, a network, and one or more homes. A user can connect to the web-based host using a remote device via a network such as the Internet. The web-based host provides the user with an interface for monitoring and/or controlling home devices in the user's home. Via the interface, the user can select one or more home devices in the user's home to monitor and/or control. The web-based host receives the user's selections and communicates the user's selections to the user's home via the network. The user's home then receives the user's selections and causes monitoring information to be obtained from selected home devices and/or causes the behavior of selected home devices to be controlled according to the user's selections. The user's home can then communicate monitoring and/or other information related to the home devices to the web-based host via the network. The web-based host then communicates the monitoring and/or other information related to the home devices to the remote device via the network where the information is displayed.

Other embodiments, aspects, and advantages of the present invention will become apparent from the following descriptions, the accompanying drawings, and the appended claims.

### BRIEF DESCRIPTION OF THE DRAWINGS

For a more complete understanding of the present invention and for further embodiments, aspects, and advantages, reference is now made to the following description taken in conjunction with the accompanying drawings, in which:

FIG. 1 is a block diagram of an exemplary web-based system for controlling and/or monitoring home devices, according to some embodiments of the present invention.

FIGS. 2A and 2B are block diagrams of exemplary remote devices, according to some embodiments of the present invention.

FIG. 3 is a block diagram of an exemplary home, according to some embodiments of the present invention.

FIGS. 4A, 4B, 4C, and 4D are block diagrams of exemplary homes showing different configurations for the home attendants within the homes, according to some embodiments of the present invention.

FIGS. 5A and 5B are block diagrams of exemplary home devices, according to some embodiments of the present invention.

FIG. 6 is a block diagram an exemplary web-based host, according to some embodiments of the present invention.

FIG. 7 is a flowchart of an exemplary method of generating a user account, according to some embodiments of the present invention.

FIG. 8 is a flowchart of an exemplary method for configuring home devices in a user's home, according to some embodiments of the present invention.

FIG. 9 is a flowchart of an exemplary method for remotely monitoring and/or controlling home devices in a user's home, according to some embodiments of the present invention.

FIG. 10 is a flowchart of an exemplary method for logging and/or notifying a user of an event that has been detected by a home device, according to some embodiments of the present invention.

FIG. 11 is a flowchart of an exemplary method for operating a remote device, according to some embodiments of the present invention.

### DETAILED DESCRIPTION OF THE INVENTION

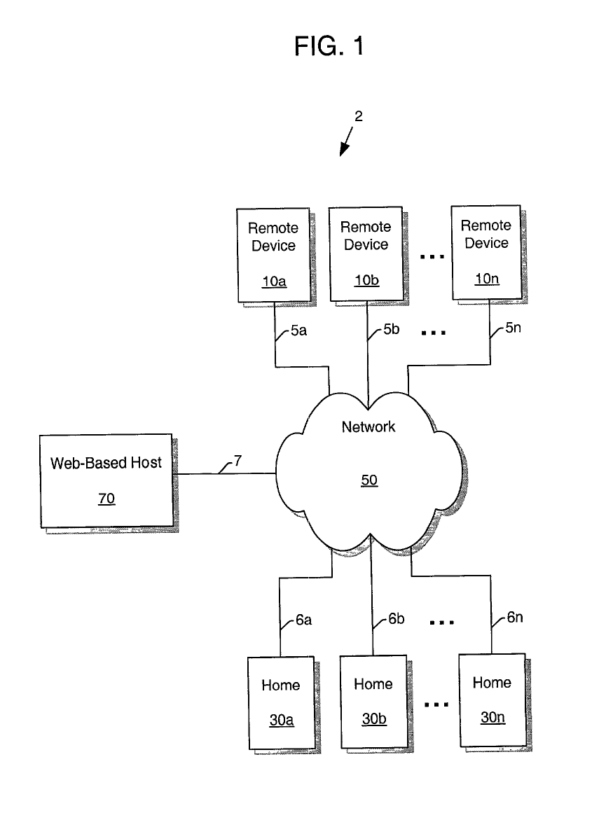

The preferred embodiments of the present invention and their advantages are best understood by referring to FIGS. 1-11 of the drawings. Like reference numerals are used for like and corresponding components of the various drawings. Components labeled with a reference numeral followed by “n” (where n=a, b, c, . . . ) indicate a plurality of such components. As used herein, the term “software” refers to one or more computer programs which include computer instructions. Software can be stored on a computer readable storage medium such as any type of memory, a magnetic disk, a CD-ROM, or the like.

System Architecture

FIG. 1 is a block diagram of an exemplary web-based system 2 for controlling and/or monitoring home devices, according to some embodiments of the present invention. Web-based system 2 includes a plurality of remote devices 10n, a plurality of homes 30n, a network 50, and a web-based host 70.

Remote devices 10n are connected to network 50 via respective connections 5n. Connections 5n can be any type of suitable connections that allow data/information to be transferred between remote devices 10n and network 50 such as a wireless gateway connection (e.g., if remote device 10n is a cellular telephone) or a digital subscriber line (DSL) connection (e.g., if remote device 10n is a desktop computer). Connections 5n can be secure connections utilizing any suitable security protocol such as SSL, SHTTP, or any other encryption/cryptography technologies.

Homes 30n are connected to network 50 via respective connections 6n. Connections 6n can be any type of suitable connections that allow data/information to be transferred between homes 30n and network 50 such as 56 Kbps dial-up modems, cable modems, DSL modems, fiber optic modems, or any combination thereof. Connections 6n can be secure connections utilizing any suitable security protocol such as SSL, SHTTP, or any other encryption/cryptography technologies.

Web-based host 70 is connected to network 50 via connection 7. Connection 7 can be any type of connection that allows data/information to be transferred between web-based host 70 and network 50. Connection 7 can be a secure connection utilizing any suitable security protocol such as SSL, SHTTP, or any other encryption/cryptography technologies.

Network 50 can be any type of network such as a global area network (GAN) (e.g., the Internet), a wide area network (WAN), a metropolitan area network (MAN), a local area network (LAN), or any combination thereof.

Remote Device Architecture

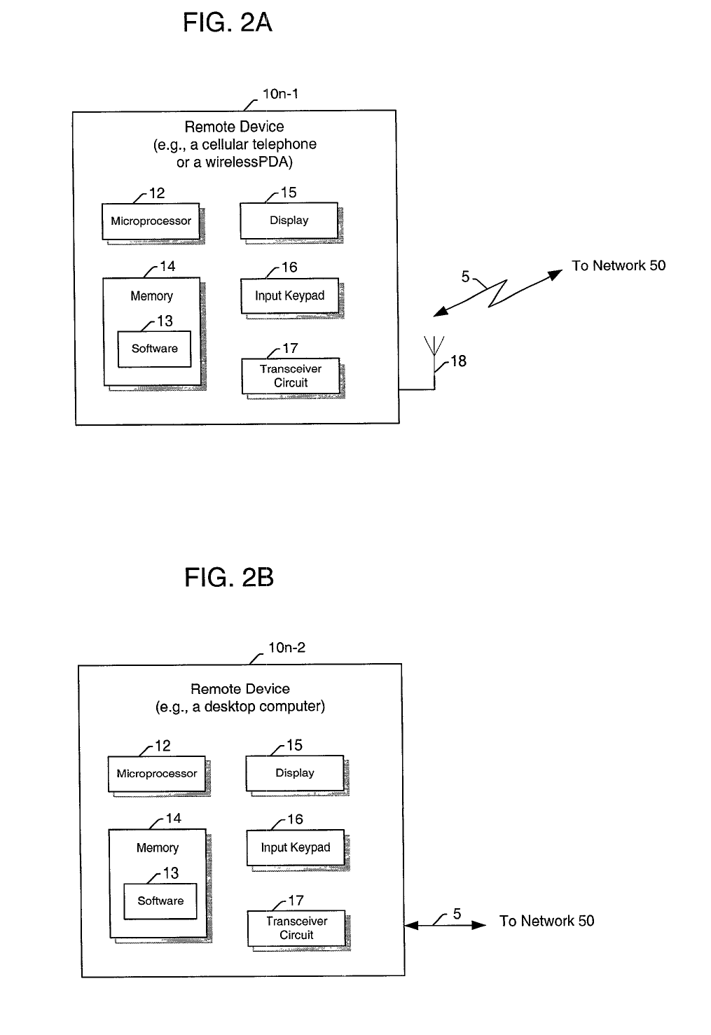

FIGS. 2A and 2B are block diagrams of exemplary remote devices 10n, according to some embodiments of the present invention. In general, remote devices 10n can be any type of electronic devices which are capable of communicating with web-based host 70 via network 50. For clarity, connections between the components of exemplary remote devices of FIGS. 2A and 2B are not shown.

FIG. 2A is a block diagram of an exemplary wireless remote device 10n-1. Remote device 10n-1 includes the following components: a microprocessor 12 capable of executing software 13 stored in memory 14, a display 15 for displaying information to a user, an input keypad 16 for accepting user input, and a transceiver circuit 17 for transmitting data/information to and receiving data/information from network 50 via antenna 18. Remote device 10n-1 can be any type of wireless device such as a cellular telephone, a wireless PDA, or a wireless computer. Software 13 generally includes any suitable operating system and any suitable microbrowser. As shown, connection 5 provides a wireless connection for transmitting data/information between device 10n-1 and network 50.

FIG. 2B is a block diagram of an exemplary wired remote device 10n-2. Remote device 10n-2 includes the following components: a microprocessor 12 capable of executing software 13 stored in memory 14, a display 15 for displaying information to a user, an input keypad 16 for accepting user input, and a transceiver circuit 17 for transmitting data/information to and receiving data/information from network 50. Remote device 10n-2 can be any type of wired device such as a desktop computer or a wired PDA. Software 13 generally includes any suitable operating system and any suitable browser (e.g., Internet Explorer). As shown, connection 5 provides a wired connection for transmitting data/information between device 10n and network 50.

It should be understood that remote devices 10n-1 and 10n-2 of FIGS. 2A and 2B are merely examples and that other remote devices 10n may not include all of the components shown and/or may include additional components.

Home Architecture

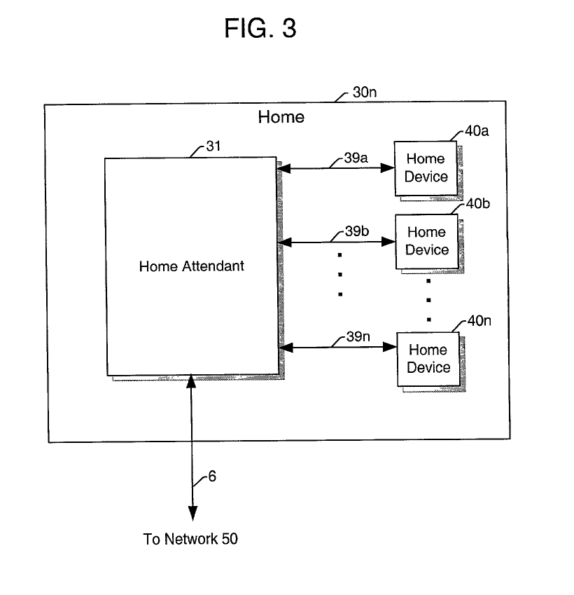

FIG. 3 is a block diagram of an exemplary home 30n, according to some embodiments of the present invention. Home 30n can be any type of residence such as a home, a condominium, or an apartment. Home 30n includes a home attendant 31 and a plurality of home devices 40n.

Home attendant 31 communicates with web-based host 70 via connection 6 and network 50. In operation, web-based host 70 can communicate data/information to home attendant 31. Home attendant 31 can then use the communicated data/information to control the behavior of home devices 10n and/or collect data/information from home devices 40n. Home attendant 31 can then communicate the collected data/information to web-based host 70. Web-based host 70 can log the collected data/information in a database and/or communicate the data/information to a user's remote device 10n.

Home attendant 31 can also monitor home devices 40n. Upon the occurrence of an event on a home device 40n, home attendant 31 can communicate that the event has occurred to web-based host 70. The event can be communicated to web-based host 70 immediately or at a later time. Web-based host 70 can then log the event in a database and/or communicate the data/information to a user's remote device 10n. Web-based host 70 can then communicate the event to a user immediately or at a later time.

Connections 39n can be any type of connections which allow data/information to be transferred between home attendant 31 and home devices 40n. For example, connections 39n can be powerline connections such as X10, CeBus, or LonWorks connections, wireless connections such as Bluetooth connections or other radio frequency (RF) connections, or any combination thereof.

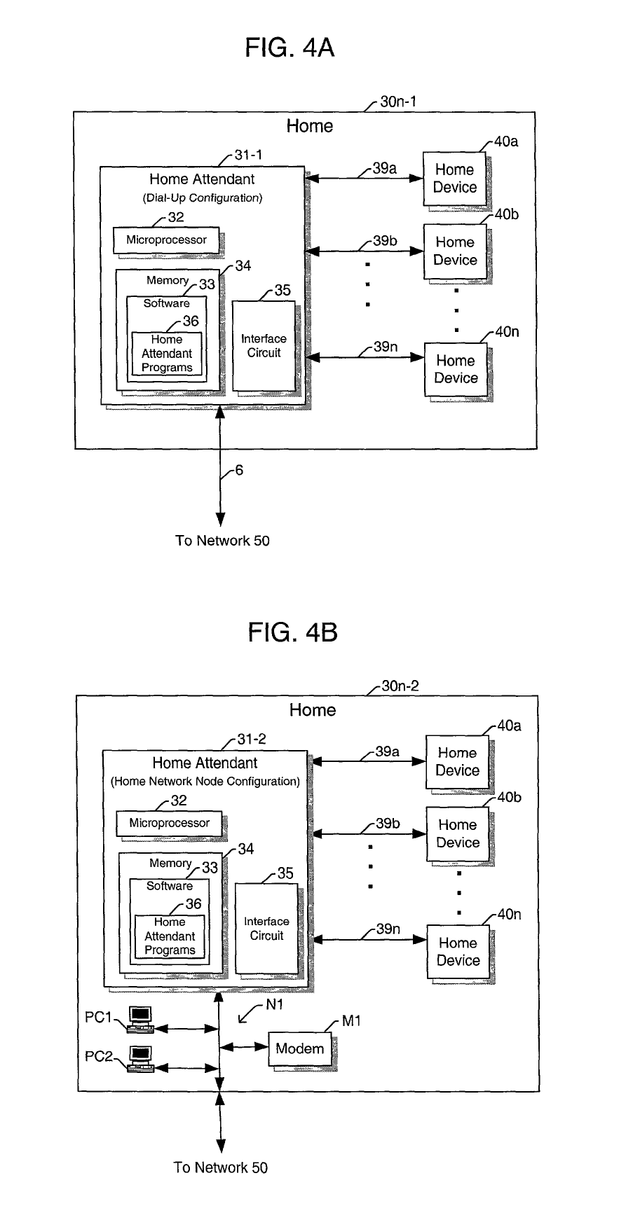

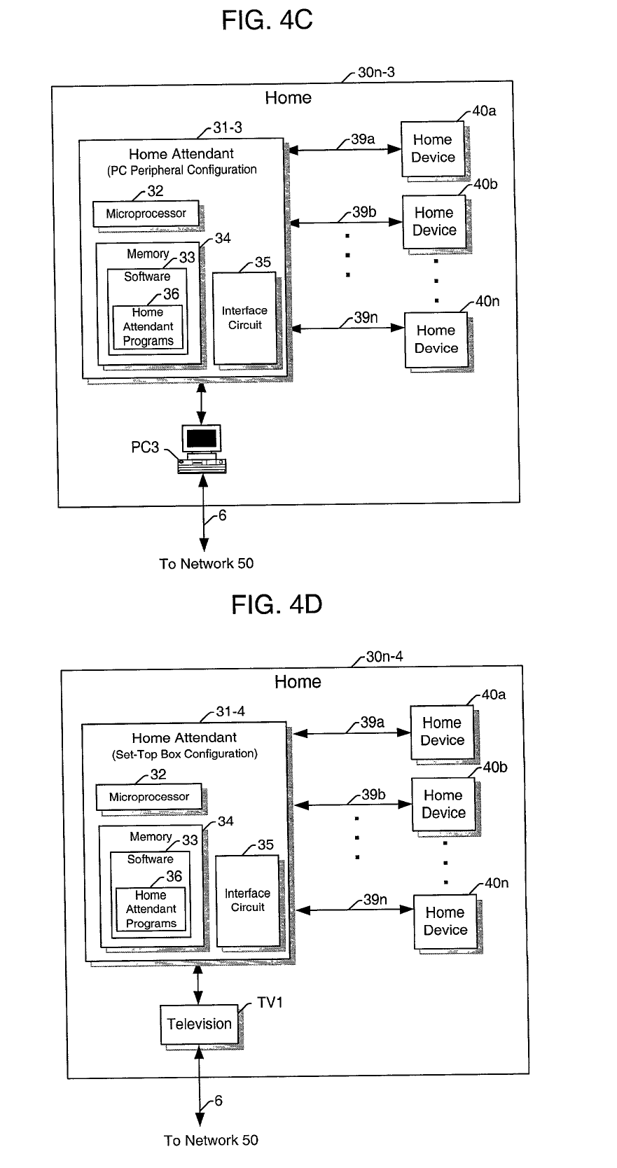

FIGS. 4A, 4B, 4C, and 4D are block diagrams of exemplary homes 30n-1, 30n-2, 30n-3, and 30n-4, respectively, showing different configurations for the home attendants 31, according to some embodiments of the present invention. For clarity, not all of the connections between the components within the exemplary home attendants 31 of FIGS. 4A, 4B, 4C, and 4D are shown.

In FIG. 4A, home attendant 31-1 of home 30n-1 is configured as a stand-alone device which communicates with network 50 via a dial-up modem (not shown). Home attendant 31-1 includes a microprocessor 32 capable of executing software 33 stored in memory 34, and an interface circuit 35 used to communicate with home devices 40n and network 50. Software 33 includes home attendant programs 36 (discussed below). Interface circuit 35 includes a dial-up modem that is connected to connection 6. The dial-up modem (not shown) allows home attendant 31-1 to communicate with web-based host 70 via network 50.

In FIG. 4B, home attendant 31-2 of home 30n-2 is configured as a stand-alone device connected to a home network N1. Home attendant 31-2 includes a microprocessor 32 capable of executing software 33 stored in memory 34, and an interface circuit 35 used to communicate with home devices 40n and network N1. Software 33 includes home attendant programs 36 (discussed below). Interface circuit 35 includes a network card (not shown) that allows home attendant 31-2 to communicate with personal computers PC1 and PC2 and modem M1. Modem M1 can be any type of modem such as a DSL or cable modem that provides an interface to network 50 via connection 6. Although not shown, home devices 40n can also be connected to home network N1.

In FIG. 4C, home attendant 31-3 of home 30n-3 is configured as a peripheral of a personal computer PC3. Home attendant 31-3 includes a microprocessor 32 capable of executing software 33 stored in memory 34, and an interface circuit 35 used to communicate with home devices 40n and personal computer PC3. Software 33 includes home attendant programs 36 (discussed below). Home attendant 31-3 and personal computer PC3 can be connected via any standard personal computer interface such as a USB connection. Personal computer PC3 generally includes a modem (not shown) for interfacing with network 50 via connection 6.

In FIG. 4D, home attendant 31-4 of home 30n-4 is configured as a set-top box for a television TV1. Home attendant 31-4 includes a microprocessor 32 capable of executing software 33 stored in memory 34, and an interface circuit 35 for communicating with home devices 40n and television TV1. Software 33 includes home attendant programs 36 (discussed below). Interface circuit 35 includes a cable modem (not shown) that is connected to connection 6. The cable modem allows home attendant 31-4 to communicate with web-based host 70 via network 50.

Home attendant programs 36 include at least the following programs/applications: an application that enables communication between home attendant 31 and home devices 40n; an application that enables communication between home attendant 31 and web-based host 70 via network 50; an application that interprets home configuration information (discussed below) communicated to home attendant 31 from web-based host; an application that sends appropriate commands to home devices 40n such that they operate according to the home configuration information; an application that monitors the home configuration information and changes the configuration of home devices 40n according to the home configuration information; and an application that causes home devices 40n to be monitored and/or controlled in response to actions initiated by a user of a remote device 10n.

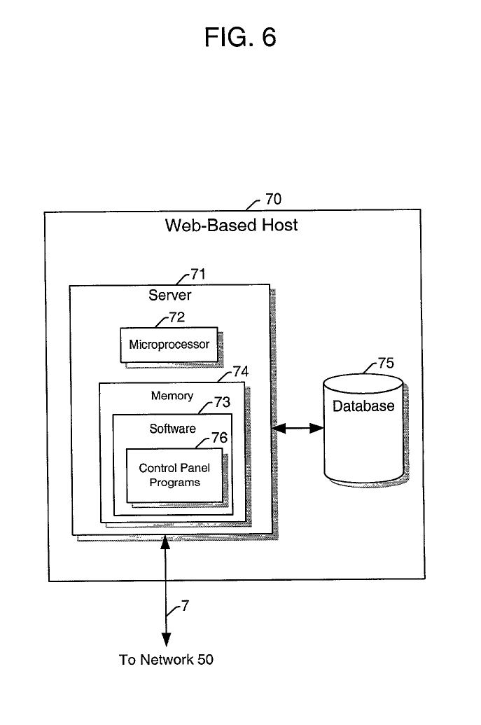

Home attendant programs 36 can also include Java™ and Jini™ programs/applications which allow home attendant 31 to operate as a “peripheral” device of web-based host 70. In such cases, each home device 40n can be represented by a respective object (e.g., a front porch light object for the front porch light, or a thermostat object for the thermostat, a security system object for the security system) stored on home attendant 31. Web-based host 70 can then use Java™ Remote Method Invocation (RMI) techniques to access and invoke methods associated with the objects stored on home attendant 31. This approach reduces the cost and complexity of home attendant 31, allowing resource intensive operations such as configuration, user interface management, and data logging to be managed and performed by servers 71 at web-based host 70 (FIG. 6).

It should be understood that home attendants 31-1, 31-2, 31-3, and 31-4 are merely examples and that various modification of home attendants are within the scope of the present invention. For example, home attendants 31 can include other features such as a displays and input keypads that allow a user to directly access home attendant 31 and to generate and/or modify configuration information and/or control and/or monitor home devices 40n. As another example, the functionality of home attendant 31 can be incorporated into one or more of the home devices 40n eliminating the need for a separate home attendant 31.

Home Device Architecture

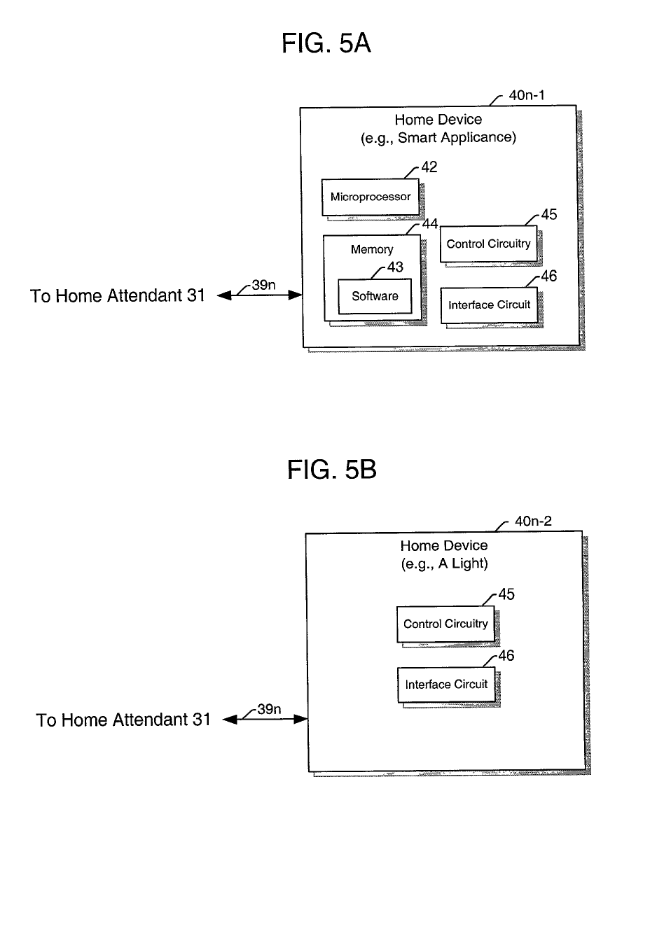

FIGS. 5A and 5B are block diagrams of exemplary home devices 40n, according to some embodiments of the present invention. As used herein, the term “home devices” broadly refers to any type of device located in a home that can communicate with home attendant 31 such as home appliances, electrical devices such as lights, home sensors, home security systems, video cameras, audio devices, remote controls for entertainment devices and the like, touch screens, thermostats, high power devices such as pool pumps, outdoor power modules and other like systems and devices located in a home, apartment, condominium, or the like. For clarity, not all of the connections between the components within the exemplary home devices of FIGS. 5A and 5B are shown.

FIG. 5A is a block diagram of an exemplary home device 40n-1, according to some embodiments of the present invention. Home device 40n-1 is a relatively complex home device such as a smart appliance. Home device 40n-1 includes a microprocessor 42 capable of executing software 43 stored in memory 44, control circuitry 45, and an interface circuit 46 for communicating with home attendant 31 via connection 39n. Operating together, microprocessor 42, software 43, and control circuitry 45 can process commands received by home attendant 31 thereby changing the behavior of home device 40n-1 or providing home device status information to home attendant 31.

FIG. 5B is a block diagram of an exemplary home device 40n-2, according to some embodiments of the present invention. Home device 40n-2 is a relatively simple home device such as a light switch. Home device 40n-2 includes control circuitry 45 and an interface circuit 46 for communicating with home attendant 31 via connection 39n. Control circuitry 45 can process commands received by home attendant 31 thereby changing the behavior of home device 40n-1 or providing home device status information to home attendant 31.

It should be understood that home devices 40n-1 and 40n-2 are merely examples and that various modifications of home devices are within the scope of the present invention.

Web-Based Host Architecture

FIG. 6A is a block diagram an exemplary web-based host 70, according to some embodiments of the present invention. Web-based host 70 can be operated by various entities such as an application solution provider (ASP), an Internet service provider (ISP), or a portal such as Yahoo, Excite, or AOL.

Web-based host 70 includes a server 71 having a microprocessor 72 which is capable of executing software 73 stored in memory 74, and a database 75 connected to server 71. Software 73 includes control panel programs 76 (discussed below). Control panel programs 76 includes a suite of programs/applications that perform a wide variety of functions related to the present invention. Server 71 can include a plurality of physical computers (e.g., a server farm or cluster), and software 73 may run on one or more of the plurality of physical server computers. Server 71 can be a desktop computer, a mainframe, a file server, a workstation, or any other suitable data processing facility. Server 71 can operate under the control of any suitable operating system such as MS-DOS, MacINTOSH OS, Windows NT, Windows 98, Windows 2000, OS/2, AIX, OS/390, OS/400, VMS, Unix, Linux, Solaris, and the like.

Control panel programs 76 can include at least the following applications: an application that enables secure communication between web-based host 70 and remote devices 10n via network 50; an application that enables secure communications between web-based host 70 and homes 30n via network 30 (e.g., an SSL application, an encryption application, etc.); an application that, at the time a secure connection is established between web-based host 70 and a remote device 10n, detects the type of remote device 10n that the user is using so that web-based host 70 can communicate appropriate graphical file formats to remote device 10n (e.g., communicating RTML files if remote device 10n is a personal computer or communications WML files if remote device 10n is a cellular telephone); an application that communicates appropriate graphical interface files having fields to remote devices 10n operated by users such that the user can enter account information, home configuration information, authentication information, home device monitoring and/or control information, and the like; an application that allows web-based host 70 to access and invoke methods on remote objects (e.g., a Java™/Jini™/Java™ RMI based application); an application for querying and otherwise accessing database 75 (e.g., an SQL database interface, an JDBC database interface, etc.); and an application for sending alerts and messages to remote devices 10n (e.g., WAP alerts, SMS messages, or SNPP paging).

System Operation

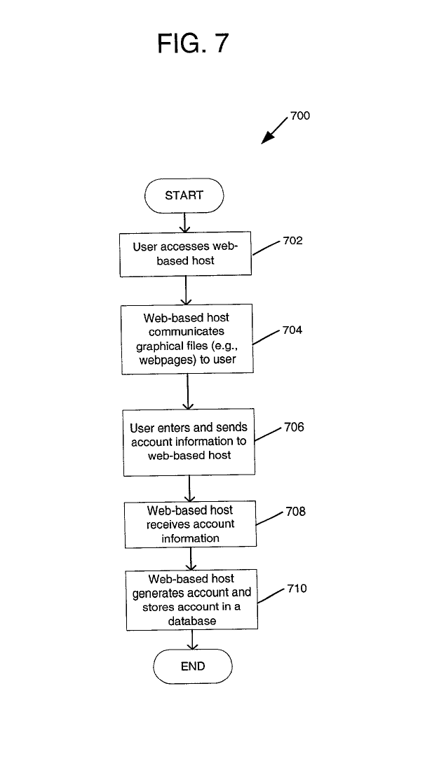

FIGS. 7 through 10 describe methods that can be performed on web-based system 2, according to some embodiments of the present invention. Skilled artisans will recognize that the methods described with reference to FIGS. 7-10 can be implemented using a variety of software technologies/architectures. For example, the methods described with reference to FIGS. 7-10 can be implemented using a distributed object architecture based on Java™ and Jini™ technologies, and in particular, using Java™ RMI technologies. Java™ RMI is a distributed object system that allows a client machine to reference an object running on a server machine and invoke methods on an object stored on the server machine as if the object were a local object running on the client machine. A description of Java™ RMI can be found in “Java Enterprise In A Nutshell,” (1999), by David Flanagan, Jim Farley, William Crawford & Kris Magnusson, which is incorporated herein by reference in its entirety. A description of Jini™ can be found in “Professional Jini,” (2000) by Sing Li and at http://www.sun.com/jini, which are herein incorporated by reference in their entireties.

Skilled artisans will also recognize that other software technologies/architectures can be used to implement the methods of present invention, all of which are within the scope of the present invention. Such techniques can include using other techniques for communicating between distributed objects in addition to Java™ RMI such as Common Object Request Broker Architecture (CORBA) or Distributed Component Object Model (DCOM). Such techniques can also include basic socket programming techniques, where a “raw” communication channel is used to pass messages and data between two remote processes (e.g., the website and the home controller).

Account Generation

FIG. 7 is a flowchart of an exemplary method 700 of generating a user account with web-based host 70, according to some embodiments of the present invention. Once a user has established an account with web-based host 70, the user can monitor and/or control home devices 40n in the user's home 30n via a remote device 10n.

In step 702, the user accesses web-based host 70. The user can, for example, access web-based host 70 using a remote device 10n running a web browser. In step 704, the control panel programs 76 running on web-based host 70 communicate one or more graphical files (e.g., webpages) to the user. The graphical files include fields that allow the user to enter account information such as the user's home address, telephone number, payment information such as a credit card number, and other like information. In step 706, the user enters and sends the account information to web-based host 70. In step 708, the control panel programs 76 running on web-based host 70 receive the account information. In step 710, the control panel programs 76 generate an account and store the account in database 75.

Home Device Configuration

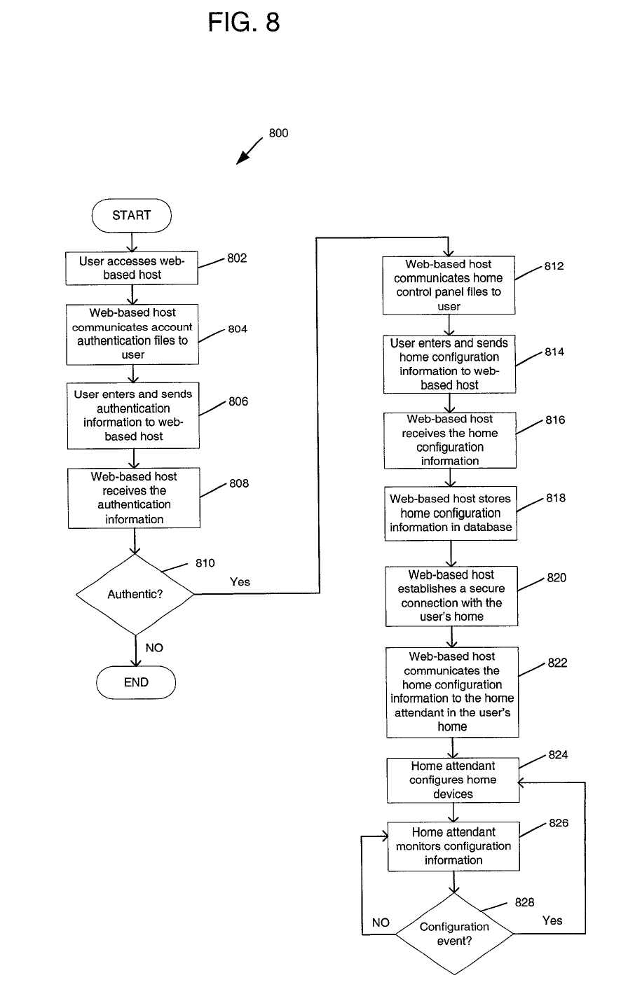

FIG. 8 is a flowchart of an exemplary method 800 for configuring home devices 40n in a user's home 30n, according to some embodiments of the present invention. Method 800 can be performed at the time a user generates an account (e.g., via method 700) and any time thereafter.

In step 802, the user accesses web-based host 70. The user can, for example, connect to web-based host 70 using a remote device 10n running a browser. In step 804, the control panel programs 76 running on web-based host 70 communicate one or more account authentication files (e.g., webpages) to the user. The account authentication files include fields that allow the user to enter authentication information such as a username and a password. In step 806, the user enters and sends the authentication information to web-based host 70. In step 808, the control panel programs 76 running on web-based host 70 receive the authentication information. In step 810, the control panel programs 76 query database 75 to authenticate the user. If the user is not properly authenticated, the method 800 ends and the user can reattempt to log in by returning to step 806. If the user is properly authenticated, method 800 proceeds to step 812.

In step 812, the control panel programs 76 running on web-based host 70 communicate one or more home control panel files (e.g., webpages) to the user. The home control panel files include fields that allow the user to enter home configuration information.

The home configuration information provided by the user allows the user to generate a customized description of their home. For example, the user can enter a description of each home device in the user's home, the unique address of each home device. The home configuration information also includes behavior information or “behavioral settings” for each device. The behavioral settings for each device can include instructions for the dates and times to turn the device on and off. The behavioral settings can also instruct the home attendant to monitor the status of home devices and to change the behavior or state of the home devices according to a user's preferences (e.g., a daytime state, an evening state, and a nighttime state for each device). The behavioral settings can also include more complex instructions such as requesting the user to be notified on their pager if the front door is opened from 9:00 AM to 5:00 PM.

If web-based system 2 is implemented using a distributed object architecture, the home configuration information can be used to generate objects corresponding to one or more of the home devices 40n in a user's home 30n. The objects can be stored on the home attendant 31 in a user's home 30n. The objects can then be accessed by web-based host 70 (e.g., via Java™ RMI) such that the behavior of the home device 40n associated with the object can be monitored, controlled, managed, diagnosed, or the like.

In step 814, the user enters and sends the home configuration information to web-based host 70. In step 816, the control panel programs 76 running on web-based host 70 receive the home configuration information. In step 818, the control panel programs 76 store the home configuration information in database 75. The home configuration information can be stored in any suitable format such as a script file.

In step 820, the control panel programs 76 establish a secure connection with the user's home 30n and, in particular, with home attendant 31 in the user's home 30n. In step 822, the control panel programs 76 communicate the home configuration information to home attendant 31 in the user's home 30n. If the home configuration information is in the form of a script file, the script file can be translated before it is communicated to home attendant 31, or home attendant 31 can translate the script file.

In step 824, home attendant 31 configures the home devices 40n according to the home configuration information. At this time, the home devices 40n are configured according to the user's initial specified behavioral settings. For example, if the behavioral settings indicate that the front porch light should be “ON” from 6:30 PM to 10:00 PM, and the current time is 7:00 PM, home controller will send an appropriate command turning the front porch light “ON.” Home attendant 31 generally stores the home configuration information in memory 34 at this time.

In step 826, home attendant 31 continuously monitors the home configuration information to configure the home devices 40n according to scheduled changes the home configuration information. If a configuration change is scheduled to occur (step 828), method 800 proceeds to step 824 where home attendant 31 configures the appropriate home devices 40n accordingly. If a configuration change is not scheduled to occur (step 828), method 800 proceeds to step 826 where home attendant 31 continues to monitor the home configuration information for scheduled configuration changes. For example, if the home configuration information includes a front porch light schedule which indicates that the front porch light is scheduled to be “ON” from 6:30 PM to 10:00 PM, and the current time is 6:30 PM, home attendant 31 sends and an appropriate command to the front porch light turning it “ON” at 6:30 PM. Home attendant 31 then continues to monitor the front porch light schedule and, when the time is 10:00 PM, home attendant 31 sends an appropriate command to the front porch light turning it “OFF” at 10:00 PM.

Remote Monitoring and/or Control of Home Devices

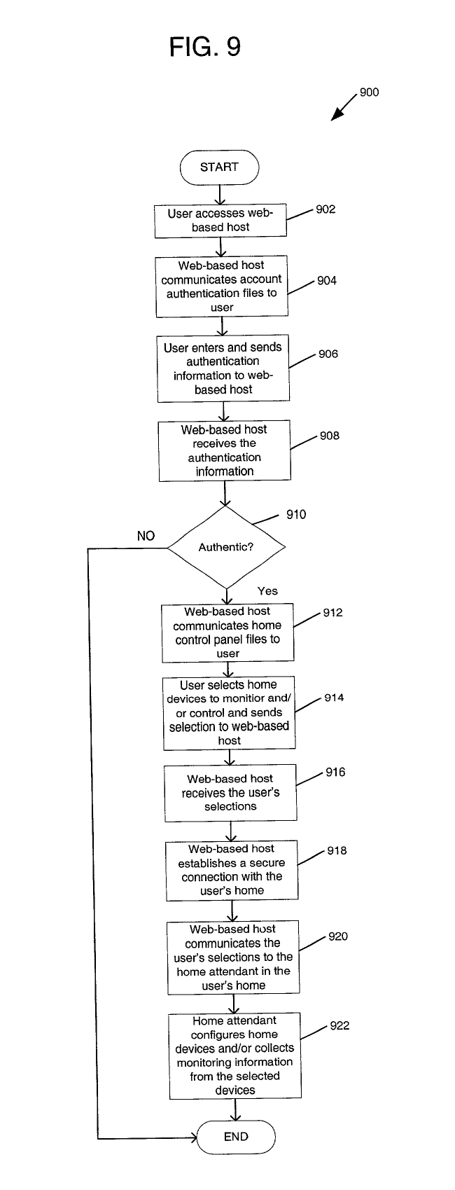

FIG. 9 is a flowchart of an exemplary method 900 for remotely monitoring and/or controlling home devices 40n in a user's home, according to some embodiments of the present invention.

In step 902, a user accesses web-based host 70. The user can, for example, connect to web-based host 70 using a remote device 10n running a web browser. In step 904, the control panel programs 76 running on web-based host 70 communicate one or more account authentication files (e.g., webpages) to the user. The account authentication files include fields that allow the user to enter authentication information such as a username and a password. In step 906, the user enters and sends the authentication information to the web-based host. In step 908, the control panel programs 76 running on web-based host 70 receive the authentication information. In step 910, the control panel programs 76 query database 75 to authenticate the user. If the user is not properly authenticated, the method 900 ends and the user can reattempt to log in (step 906). If the user is properly authenticated, method 900 proceeds to step 912.

In step 912, the control panel programs 76 running on web-based host 70 communicate one or more control panel files (e.g., webpages) to the user. The home control panel files include fields that allow the user to monitor and/or control home devices 40n in the user's home 30n.

In step 914, the user selects one or more home devices 40n to monitor and/or control and the user's selections are sent to web-based host 70. In step 916, the control panel programs 76 running on web-based host 70 receive the user's selections.

In step 918, the control panel programs 76 establish a secure connection with the user's home 30n and, in particular, with home attendant 31 in the user's home 30n. In step 920, the control panel programs 76 communicate the user's selections to home attendant 31.

In step 922, home attendant 31 configures the selected home devices 40n pursuant to the user's selection and/or collects monitoring information from the selected home devices 40n. For example, if the user's selection requested the thermostat to be turned to 70 degrees immediately, home attendant 31 sends an appropriate command to the thermostat causing it to be turned to 70 degrees. As another example, if the user's selection requested the current temperature of the thermostat to be obtained, home attendant 31 sends an appropriate command to the thermostat causing the thermostat's current temperature to be read. Home attendant 31 can then communicate this information back to the control panel programs. The control panel programs can then communicate this to the user's remote device 10n where the information is displayed.

Home Event Logging and/or Notification

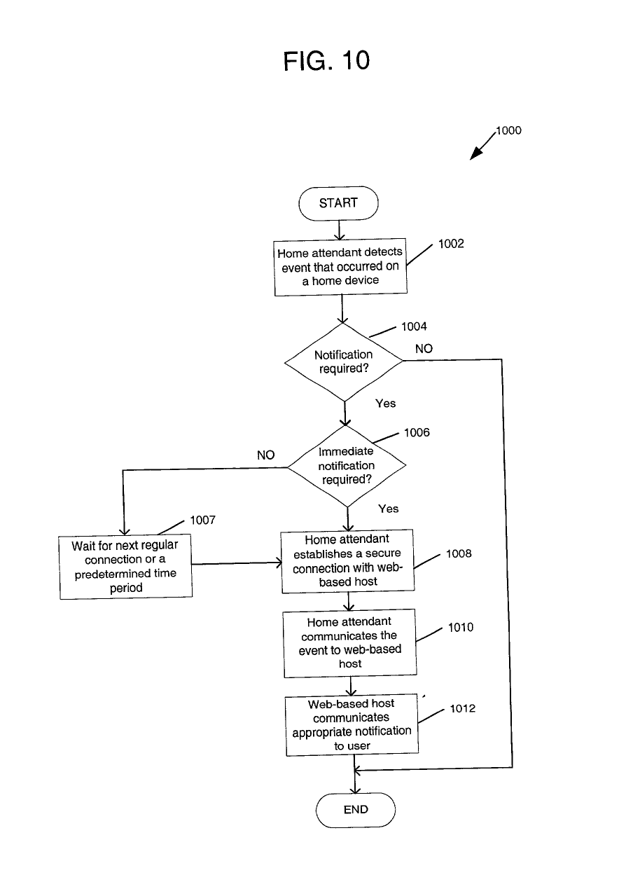

FIG. 10 is a flowchart of an exemplary method 1000 for logging and/or notifying a user of an event that has been detected by a home device 30n, according to some embodiments of the present invention. Method 1000 can be used, for example, to alert a user of an intrusion into the user's home 30n.

In step 1002, home attendant 31 detects an event which has occurred on a home device 40n. In step 1004, home attendant 31 determines whether this event requires notification. Home attendant 31 can make this determination by accessing event notification information in the home configuration files (discussed above). If the event does not require notification, method 1000 ends. If the event requires notification, method 1000 proceeds to step 1006.

In step 1006, home attendant 31 determines whether the event requires immediate notification (e.g., if the home security system detects a breach of security). Home attendant 31 can determine the urgency of the notification from the notification information in the home configuration files. If the event requires immediate notification, method 1000 immediately proceeds to step 1008 where the home attendant 31 establishes a connection with web-based host 70 and communicates the event to web-based host 70. If the event does not require immediate notification, method 1000 proceeds to 1007 where home attendant 31 stores a record of the event in its memory 34 and waits until the next time a connection is established between web-based host 70 and home attendant 31 to communicate the event to web-based host 10.

In step 1010, home attendant 31 communicates the event to the control panel programs 76 running on web-based host 70. In step 1012, web-based host logs the event in its database and/or sends an appropriate notification to the user. The notification can be sent to one or more remote devices 10n possessed by the user or any other electronic notification device such as a pager. Web-based host 70 can also access information provided by the user (and stored in the database) which indicates how and when to communicate the event to the user (e.g., immediately report the event via a pager message or email message).

### Example

### Remote Control of a Home Device Using Java™ and Jini™ Technologies

FIGS. 7-10 have described in general an exemplary account generation method (method 700), an exemplary home device configuration method (method 800), an exemplary remote monitoring and/or control method (method 900), and an exemplary home event logging and/or notification method (method 1000), all of which can be performed on web-based system 2 (FIG. 1). As mentioned above, such methods can be implemented using a wide variety of software technologies/architectures. For example, objects associated with each home device 40n can be stored on home attendant 31. Each of these objects can be located by web-based host 70 using the Jini™ lookup service and controlled and/or monitored by using methods similar to method 1100.

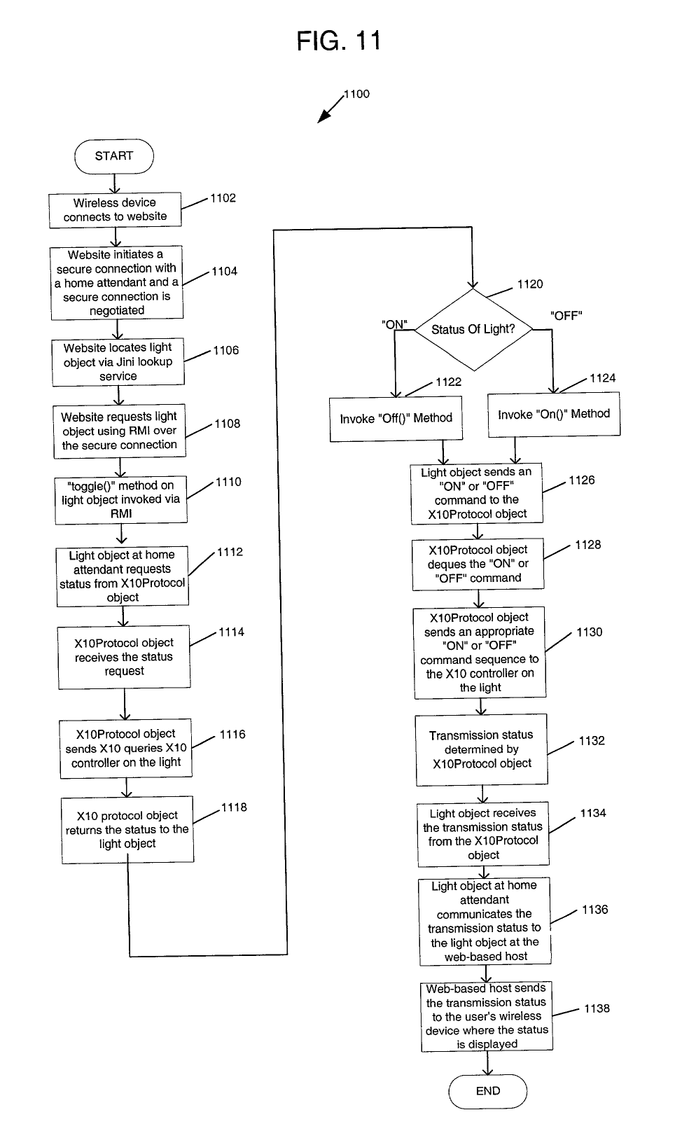

FIG. 11 is intended to show an example of how Java™ and Jini™ technologies can be used to remotely control a home device 40n. In particular, method 1100 describes how a user can use a remote device 10n to toggle (e.g., turn the light off if the light is currently on, or turn the light on if the light is currently off) a home device 40n which is a light in the user's home 30n. Method 1100 assumes that a “light object” and a “X10Protocol object” exist on home attendant 31. The light object includes a “toggle( )” method for communicating with the X10Protocol object, an “On( )” or “Off( )” method for turning the light in the user's home 30n on or off, and a “status( )” method that returns the current status of the light (i.e., “ON,” “OFF,” or “Unknown”).

In step 1102, a user connects to a website 70 using a remote device 10. Via a browser, the user logs into their account, which is stored in database 75 of website 70, and requests a light to be turned on in the user's home 30. The website then receives the user's request and method 1102 proceeds to step 1104.

In step 1104, the website initiates a secure socket layer (SSL) connection with the home attendant 31 in the user's home. The SSL connection is then fully negotiated. In step 1106, the website locates the user selected light object using the Jini™ lookup service. In step 1108, the website requests the light object using RMI over the SSL connection and obtains a shadow copy of the light object. In step, 1110 the “toggle( )” method on the light object is invoked via RMI.

In step 1112, the light object at home attendant 31 invokes the “status( )” method which requests status from the X10Protocol object. In step 1114, the X10Protocol object at the home attendant 31 retrieves the status request from the light object. In step 1116, the X10Protocol object queries the X10 controller on the light to determine whether the light is “ON” or “OFF.” In step 1118, the X10Protocol object returns the status to the light object (i.e., via the “status( )” method) which was obtained from the X10 controller. In step 1120, the light object invokes either the “On( )” or “Off( )” method on the light object depending on the status of the light. If the status of the light is on, then the “Off( )” method is invoked (step 1122). If the status of the light is off, then the “On( )” method is invoked (step 1124).

In step 1126, the light object sends an “ON” or “OFF” command to the X10Protocol object. In step 1128, the X10Protocol object deques the “ON” or “OFF” command. In step 1130, the X10 Protocol object send an appropriate “ON” or “OFF” X10 command sequence to the X10 controller on the light.

In step 1132, the X10 controller returns the transmission status (e.g., whether the X10 command sequence was successfully or unsuccessfully transmitted) to the X10Protocol object. In step 1134, the light object receives the transmission status from the X10Protocol object. In step 1136, the light object at the home attendant 31 sends the transmission status to the light object at the website. The transmission status is sent to the light object at the website using RMI over the SSL connection.

In step 1138, the website sends the transmission status to the user's remote device 10n. The user's remote device then displays the transmission status via the browser running on the user's remote device.

Advantages of the Present Invention

From the above description, it should be apparent that the present invention provides at least the following advantages. First, user's can monitor and/or control home devices in their home from virtually anywhere in the world using cellular telephones, wireless PDA's, desktop computers, or any other electronic devices which can connect to a network such as the internet. Second, if a distributed object architecture is used, resource intensive functions can be performed by computers at the web-based host. As a result, the home attendant's complexity can be minimized and thus the cost of the home attendant can be reduced. Third, the web-based system can use existing encryption and protocol technologies to ensure that the communication of data/information on the web-based system is secure. Thus, intruders and hackers will not be able to access home attendants and thereby gain unauthorized control of the home devices in a user's home.

While particular embodiments of the present invention and their advantages have been shown and described, it should be understood that various changes, substitutions, and alterations can be made therein without departing from the spirit and scope of the invention as defined by the appended claims.

We claim:

1. A method for remotely monitoring and/or controlling a home device performed on a web-based host, the method comprising:
establishing a connection with a remote device;
receiving monitoring and/or control information from the remote device;
establishing a connection with a home; and
communicating the monitoring and/or control information to the home, wherein the monitoring and/or control information causes monitoring information to be obtained from a home device in the home and/or causes the a home device in the home to be controlled.

2. The method of claim 1 further comprising:
receiving authentication information from the remote device; and
determining at the web-based host whether a user of the remote device has permission to access the home.

3. The method of claim 1 further comprising:
communicating graphical interface files to the remote device, the graphical interface files for allowing a user of the remote device to select a home device to monitor and/or control and for allowing the user of the remote device to specify how to monitor and/or control the home device.

4. The method of claim 1 further comprising:
encrypting the monitoring and/or control information before the monitoring and/or control information is communicated to the home.

5. The method of claim 1 further comprising:
receiving home device status information in response to the step of communicating the monitoring and/or control information from the web-based host to the home; and
communicating the home device status information to the remote device.

6. The method of claim 1 further comprising:
establishing a connection with the home if a home device in the home has detected an event;
receiving information which describes the event; and
communicating the information which describes the event to a user.

7. The method of claim 1 wherein the remote device is a wireless telephone, a wireless personal digital assistant, or a wireless computer.

8. The method of claim 1 wherein the remote device is a wired telephone, a wired personal digital assistant, or a wired computer.

9. A computer system for remotely monitoring and/or controlling a home device, the computer system comprising:
one or more computers connected to one or more remote devices via a network;
one or more computer programs executable by the computers, wherein the computer programs comprise computer instructions for:
establishing a connection with a remote device;
receiving monitoring and/or control information from the remote device;
establishing a connection with a home; and
communicating the monitoring and/or control information to the home, wherein the monitoring and/or control information causes monitoring information to be obtained from a home device in the home and/or causes the a home device in the home to be controlled.

10. The computer system of claim 9 wherein the computer programs further comprise computer instructions for:
receiving authentication information from the remote device; and
determining at the web-based host whether a user of the remote device has permission to access the home.

11. The computer system of claim 9 wherein the computer programs further comprise computer instructions for:
communicating graphical interface files to the remote device, the graphical interface files for allowing a user of the remote device to select a home device to monitor and/or control and for allowing the user of the remote device to specify how to monitor and/or control the home device.

12. The computer system of claim 9 wherein the computer programs further comprise computer instructions for:
encrypting the monitoring and/or control information before the monitoring and/or control information is communicated to the home.

13. The computer system of claim 9 wherein the computer programs further comprise computer instructions for:
receiving home device status information in response to the step of communicating the monitoring and/or control information from the web-based host to the home; and
communicating the home device status information to the remote device.

14. The computer system of claim 9 wherein the computer programs further comprise computer instructions for:
establishing a connection with the home if a home device in the home has detected an event;
receiving information which describes the event; and
communicating the information which describes the event to a user.

15. The computer system of claim 9 wherein the remote device is a wireless telephone, a wireless personal digital assistant, or a wireless computer.

16. The computer system of claim 9 wherein the remote device is a wired telephone, a wired personal digital assistant, or a wired computer.

17. A computer readable storage medium storing one or more computer programs executable by one or more computers, one or more of the computer programs comprising computer instructions for:
establishing a connection with a remote device;
receiving monitoring and/or control information from the remote device;
establishing a connection with a home; and
communicating the monitoring and/or control information to the home, wherein the monitoring and/or control information causes monitoring information to be obtained from a home device in the home and/or causes the a home device in the home to be controlled.

18. The computer readable storage medium of claim 17 wherein the computer programs further comprise computer instructions for:
receiving authentication information from the remote device; and
determnining at the web-based host whether a user of the remote device has permission to access the home.

19. The computer readable storage medium of claim 17 wherein the computer programs further comprise computer instructions for:
communicating graphical interface files to the remote device, the graphical interface files for allowing a user of the remote device to select a home device to monitor and/or control and for allowing the user of the remote device to specify how to monitor and/or control the home device.

20. The computer readable storage medium of claim 17 wherein the computer programs further comprise computer instructions for:
encrypting the monitoring and/or control information before the monitoring and/or control information is communicated to the home.

21. The computer readable storage medium of claim 17 wherein the computer programs further comprise computer instructions for:
receiving home device status information in response to the step of communicating the monitoring and/or control information from the web-based host to the home; and
communicating the home device status information to the remote device.

22. The computer readable storage medium of claim 17 wherein the computer programs further comprise computer instructions for:
establishing a connection with the home if a home device in the home has detected an event;
receiving information which describes the event; and
communicating the information which describes the event to a user.

23. The computer readable storage medium of claim 17 wherein the remote device is a wireless telephone, a wireless personal digital assistant, or a wireless computer.

24. The computer readable storage medium of claim 17 wherein the remote device is a wired telephone, a wired personal digital assistant, or a wired computer.

25. A method for monitoring and/or controlling a home device performed on a home attendant, the method comprising:
establishing a connection with a web-based host; and
receiving monitoring and/or control information from the web-based host.

26. The method of claim 25 further comprising:
communicating the monitoring and/or control information to a home device thereby causing monitoring information to be obtained from the home device and/or causing the home device to be controlled.

27. The method of claim 25 further comprising:
communicating with a home device to determine whether the home device has detected an event; and
if an event has been detected by the home device, establishing a secure connection with the web-based host and communicating the event to the web-based host.

28. The method of claim 25 further comprising:
communicating with a home device via a radio frequency connection.

29. The method of claim 25 further comprising:
communicating with a home device via a powerline connection.

30. The method of claim 25 wherein the home device is a stand-alone device, a peripheral device, a personal computer, or a television set-top box.

31. An apparatus for monitoring and/or controlling a home device, the apparatus comprising:
a microprocessor;
a memory connected to the microprocessor; and
one or more computer programs executable by the microprocessor, wherein the computer programs comprise computer instructions for:
establishing a connection with a web-based host; and
receiving monitoring and/or control information from the web-based host.

32. The apparatus of claim 31 further comprising:
communicating the monitoring and/or control information to a home device thereby causing monitoring information to be obtained from the home device and/or causing the home device to be controlled.

33. The apparatus of claim 31 further comprising:
communicating with a home device to determine whether the home device has detected an event; and
if an event has been detected by the home device, establishing a secure connection with the web-based host and communicating the event to the web-based host.

34. The apparatus of claim 31 further comprising:
communicating with a home device via a radio frequency connection.

35. The apparatus of claim 31 further comprising:
communicating with a home device via a powerline connection.

36. The apparatus of claim 31 wherein the home device is a stand-alone device, a peripheral device, a personal computer, or a television set-top box.

37. A computer readable storage medium storing one or more computer programs executable by one or more computers, one or more of the computer programs comprising computer instructions for:
establishing a connection with a web-based host; and
receiving monitoring and/or control information from the web-based host.

38. The computer readable storage medium of claim 37 wherein the computer programs further comprise computer instructions for:
communicating the monitoring and/or control information to a home device thereby causing monitoring information to be obtained from the home device and/or causing the home device to be controlled.

39. The computer readable storage medium of claim 37 wherein the computer programs further comprise computer instructions for:
communicating with a home device to determine whether the home device has detected an event; and
if an event has been detected by the home device, establishing a secure connection with the web-based host and communicating the event to the web-based host.

40. The computer readable storage medium of claim 37 wherein the computer programs further comprise computer instructions for:
communicating with a home device via a radio frequency connection.

41. The computer readable storage medium of claim 37 wherein the computer programs further comprise computer instructions for:
communicating with a home device via a powerline connection.

42. The computer readable storage medium of claim 37 wherein the home device is a stand-alone device, a peripheral device, a personal computer, or a television set-top box.
